(19) United States
(12) Patent Application Publication
(10) Pub. No.: US 2015/0068265 A1
(43) Pub. Date: Mar. 12, 2015

(54) Rebar Cutting, Bending, and Shaping

(71) Applicant: David Dickson, Cumming, GA (US)

(72) Inventor: David Dickson, Cumming, GA (US)

(21) Appl. No.: 14/482,966

(22) Filed: Sep. 10, 2014

Related U.S. Application Data
(60) Provisional application No. 61/875,949, filed on Sep. 10, 2013.

(51) Int. Cl. B23D 17/06; B21D 7/04

(52) U.S. Cl. CPC B23D 17/06; B21D 7/04
USPC 72/203; 72/332

(57) ABSTRACT

A rebar processing station taking the form of an hydraulically powered rebar cutting, bending, and shaping table is disclosed. A rebar cutting assembly comprises a pair of slotted, hardened plates or dies that cooperatively function to shear a rebar. A rebar grasping, bending, and shaping assembly comprises rebar grasping and clamping means, a shaping plate or die, and a movable former, such as a roller. For convenient transport, the table may be provided with appropriate features allowing cooperative engagement with appropriate attachments and/or implements associated with on-site construction equipment.

### RELATED APPLICATIONS

The present application claims priority to U.S. Provisional Patent Application Ser. No. 61/875,949, which was filed on Sep. 10, 2013, the entire disclosure of which is incorporated herein by reference.

### TECHNICAL FIELD

The present invention relates, generally, to devices and processes for cutting, bending, and shaping rebar; and, more particularly, to field-operable devices and processes for cutting, bending, and shaping rebar wherein an hydraulic pressure source is used in association with a table-like structure to drive rebar cutting, bending, and shaping functions.

### BACKGROUND

As is well-known in the construction industries, rebar (short for reinforcing bar), is a steel bar commonly used as a tensioning means for reinforced concrete and like structures, such as masonry. When rebar is to be used in association with such concrete structures, its function is to hold the concrete in compression—wherein the concrete is strongest. The rebar, then, functions to carry and spread the tensile loads, provide resistance to concentrated and/or bending loads, and add stiffness to the structure.

Rebar is sized (in the U.S.) from #2 bar size, corresponding to an approximate nominal diameter of ¼ inch, to #18 bar size, corresponding to an approximate nominal diameter of 2¼ inches; although greater diameter, “jumbo” bars are commonly available for large structures. Rebar is available in a number of different grade designations, and a variety of industry specifications have been established for control of rebar chemical composition, mechanical properties (such as, for example, yield strength, percentage of elongation, tensile strength, ductility, heat treatment, and the like), and surface coatings (such as, for example, zinc/galvanized coatings, epoxy coatings, and the like).

In use and application, a rebar structure is typically fabricated on-site and in advance of the concrete pour. A structural engineer or architect will have specified, in advance, the component sizes, lengths, and shapes, as well as the assembly, welding, and/or tying configuration, for each rebar structure. Depending upon the size and nature of the job, these components can be fabricated in-advance and transported to the job site for subsequent assembly, or they can be fabricated on-site using site-stocked materials.

For large jobs, rebar elements are cut (most often by shearing) and shaped, in advance, at a rebar fabrication facility using high-capacity hydraulic equipment. For smaller jobs, though, rebar elements are most often cut, bent, and shaped on-site. As will be described below, because power sources, such as electrical lines, are often unavailable on the job site during this phase of construction, on-site rebar cutting, bending, and shaping operations are typically performed by-hand. One form of manual rebar bender, known as a Hickey, is often used. The Hickey operates through manually applied leverage, and bending operations can be inaccurate, time consuming, and physically demanding.

Of course, it should be readily apparent that the force required to complete each cutting, bending, and shaping operation is dependent upon, for example, the size of the rebar, its grade, and its associated chemical and mechanical properties, such as were described above. Accordingly, only smaller sizes of rebar—typically no larger than #6 (¾ inch nominal diameter)—can be manually processed on-site.

Because electrical power often is not yet available on-site during grading and foundation pouring phases of construction, electrically powered rebar cutting, bending, and shaping tools may not be convenient or usable. Any powered tool would, accordingly, require a different and conveniently available power source for its operation and use. Additionally, in order to most efficiently and safely process rebar component parts, workers should have access to a processing station that can be conveniently placed near on-site rebar material staging areas, and subsequently relocated as-required. Such a processing station should be capable of accurately and safely cutting, bending, and shaping rebar component parts; it should be effective, convenient, and simple to operate; it should be adjustable to accommodate its operator; and it should be capable of processing a variety of sizes and grades of rebar.

Accordingly, it is to the disclosure of such devices and related processes that this disclosure is directed.

### SUMMARY

In general, the present disclosure is directed to embodiments of a rebar processing station meeting the aforedescribed requirements, and taking the form of an hydraulically powered rebar cutting, bending, and shaping table. Specifically, and pursuant to a preferred embodiment of the hydraulically powered rebar cutting, bending, and shaping table of the present disclosure, a table, preferably formed from durable, structural steel component parts, is configured with a rebar cutting assembly and with a rebar grasping, bending, and shaping assembly.

In some embodiments, the rebar cutting assembly comprises a pair of hardened shearing plates or dies, one of which is preferably stationary and one of which articulates about a pivot center. Each shearing plate or die comprises one or more peripheral, U-shaped slot or channel, configured to align with a respective, corresponding U-shaped slot or channel in the other adjacent shearing plate or die. Each U-shaped slot or channel is appropriately sized to receive a rebar therewithin, and when operating thereupon, cuts the rebar by shearing force at the interface between the adjacent shearing plates. In some embodiments, left and right-hand U-shaped slots or channels may be provided within each shearing plate or die for the convenience of the operator.

In some embodiments, a rebar grasping, bending, and shaping assembly comprises rebar grasping means, a shaping plate or die, and a movable former, such as a roller. The rebar grasping means may comprise a clamp formed by cooperative interaction between a first, fixed-position, tapered clamp portion and a second, slidable, cooperatively-tapered clamp portion. In operation, one side of a rebar is placed adjacent a fixed-position shaping die, and the slideable, tapered clamp portion is engaged against the opposite side of the rebar; thereby, clamping or grasping the rebar between the fixed-position shaping plate or die and the clamp in a stable and stationary position. Provided that the distal portion of the rebar is of sufficient length to be engaged by the movable former, which in some embodiments takes the form of a hardened steel roller operating within an arcuate field of travel, the rebar may be bent and shaped by operation of the movable former against the rebar, bending the rebar about the adjacent, fixed-position shaping plate or die. Provided, of course, that the applied bending forces are sufficient to exceed the yield strength of the rebar, the bending operation is permanent; and the rebar, accordingly, is shaped to the desired configuration.

Because these rebar cutting, bending, and shaping processes often occur contemporaneously with site preparation activities, such as site excavation, grading, and compaction; and, because construction materials must be staged and moved about the construction site, hydraulically-equipped loaders, excavators, tractors, ancillary hydraulic motors and/or power packs, and similar machines, are typically available on-site. Accordingly, hydraulic power out-takes and/or outputs typically associated with such hydraulically-equipped machines are often available for use in association with the hydraulically powered rebar cutting, bending, and shaping table of the present disclosure.

Similarly, because the hydraulically powered rebar cutting, bending, and shaping table of the present disclosure can be placed nearly anywhere on-site, the aforedescribed hydraulically-equipped loaders, excavators, tractors, and similar machines can be enlisted to transport and relocate the table about the site, as required. Accordingly, the table may be provided with appropriate features allowing cooperative engagement of the table with appropriate attachments and/or implements associated with such machines.

The hydraulically powered rebar cutting, bending, and shaping table of the present disclosure can be treated against weathering and rusting. Table legs can be made extensible, as with cooperating pin and hole arrangements. Shields and/or covers may be provided for worker safety during table operation, and to protect moving components of the table against impact and damage when not in operation.

In use and operation, a rebar is placed within the U-shaped slot or channel of the cutting assembly, the preferred cut-point is aligned along the shear interface between the adjacent shearing plates, and the cutting assembly is actuated so as to cut the rebar to its preferred length. One side of the rebar is then placed adjacent the fixed-position shaping die, and the slideable, tapered clamp portion is engaged against the opposite side of the rebar; thereby, clamping or grasping the rebar between the fixed-position shaping plate or die and the clamp in a stable and stationary position. The movable former is actuated; whereby, provided that the distal portion of the rebar is of sufficient length to be engaged by the movable former, the rebar is be bent and shaped by operation of the movable former against the rebar, bending the rebar about the adjacent, fixed-position shaping plate or die. Provided, of course, that the applied bending forces are sufficient to exceed the yield strength of the rebar, the bending operation is permanent; and the rebar, accordingly, is shaped to the desired configuration. The aforedescribed process, or subprocesses thereof, may be repeated as-required to bring each rebar into conformance with its corresponding specification.

These and other features and advantages of the various embodiments of devices and related systems comprising , as set forth within the present disclosure, will become more apparent to those of ordinary skill in the art after reading the following Detailed Description of Illustrative Embodiments and the Claims in light of the accompanying drawing Figures.

### BRIEF DESCRIPTION OF THE DRAWINGS

Accordingly, the within disclosure will be best understood through consideration of, and with reference to, the following drawing Figures, viewed in conjunction with the Detailed Description of Illustrative Embodiments referring thereto, in which like reference numbers throughout the various Figures designate like structure, and in which:

FIG. 1 illustrates a rear perspective view of an embodiment of a hydraulically powered rebar cutting, bending, and shaping table according to the present disclosure;

FIG. 2 illustrates a top plan view of the hydraulically powered rebar cutting, bending, and shaping table illustrated in FIG. 1;

FIG. 3 illustrates a front elevation view of the hydraulically powered rebar cutting, bending, and shaping table illustrated in FIG. 1;

FIG. 4 illustrates a right side elevation view of the hydraulically powered rebar cutting, bending, and shaping table illustrated in FIG. 1;

FIG. 5 illustrates a rear elevation view of the hydraulically powered rebar cutting, bending, and shaping table illustrated in FIG. 1;

FIG. 6 illustrates a top plan view of a portion of the hydraulically powered rebar cutting, bending, and shaping table illustrated in FIG. 1 in association with a pre-placed rebar, and in a configuration prior to actuation of rebar bending and shaping operations; and, further, depicting means for grasping, bending, and shaping a rebar, said rebar grasping means in an open configuration;

FIG. 7 illustrates a top plan view of a portion of the hydraulically powered rebar cutting, bending, and shaping table illustrated in FIGS. 1 and 6 in association with a pre-placed rebar, and in a configuration following actuation of rebar bending and shaping operations; and, further, depicting means for grasping, bending, and shaping a rebar, said rebar grasping means in a closed configuration;

FIG. 8 illustrates a perspective side view of a portion of the hydraulically powered rebar cutting, bending, and shaping table illustrated in FIG. 1, depicting an embodiment of a rebar cutting assembly thereof in an aligned configuration prior to activation;

FIG. 9 illustrates a perspective side view of a portion of the hydraulically powered rebar cutting, bending, and shaping table illustrated in FIGS. 1 and 8, depicting an embodiment of a rebar cutting assembly thereof in a configuration following activation; and

FIG. 10 illustrates a bottom perspective view of a portion of the hydraulically powered rebar cutting, bending, and shaping table illustrated in FIG. 1.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF ILLUSTRATIVE EMBODIMENTS

In describing the several embodiments illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose. Additionally, in the Figures, like reference numerals shall be used to designate corresponding parts throughout the several Figures.

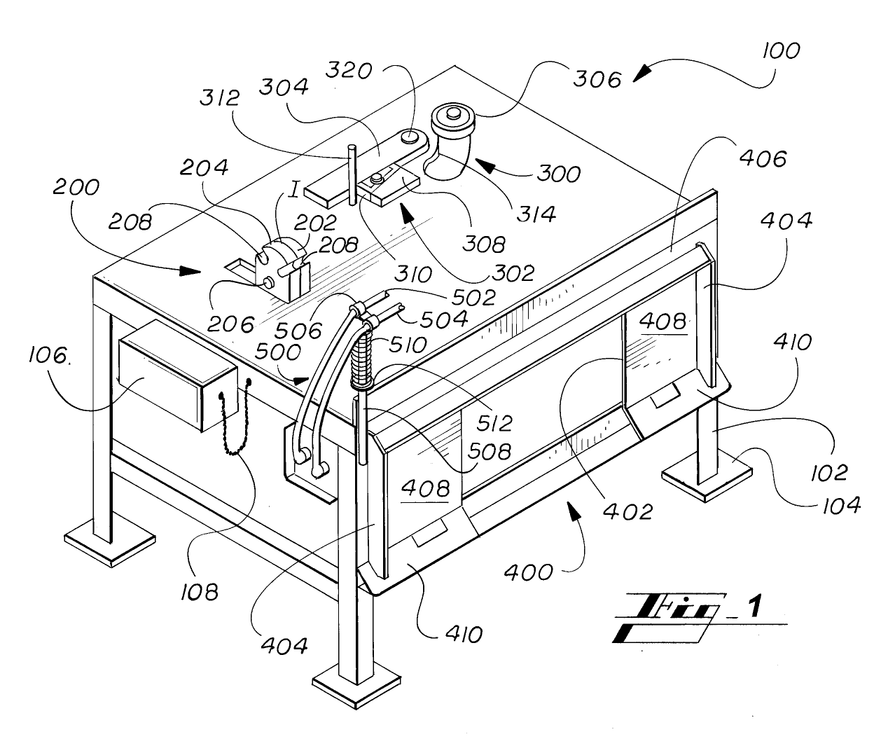

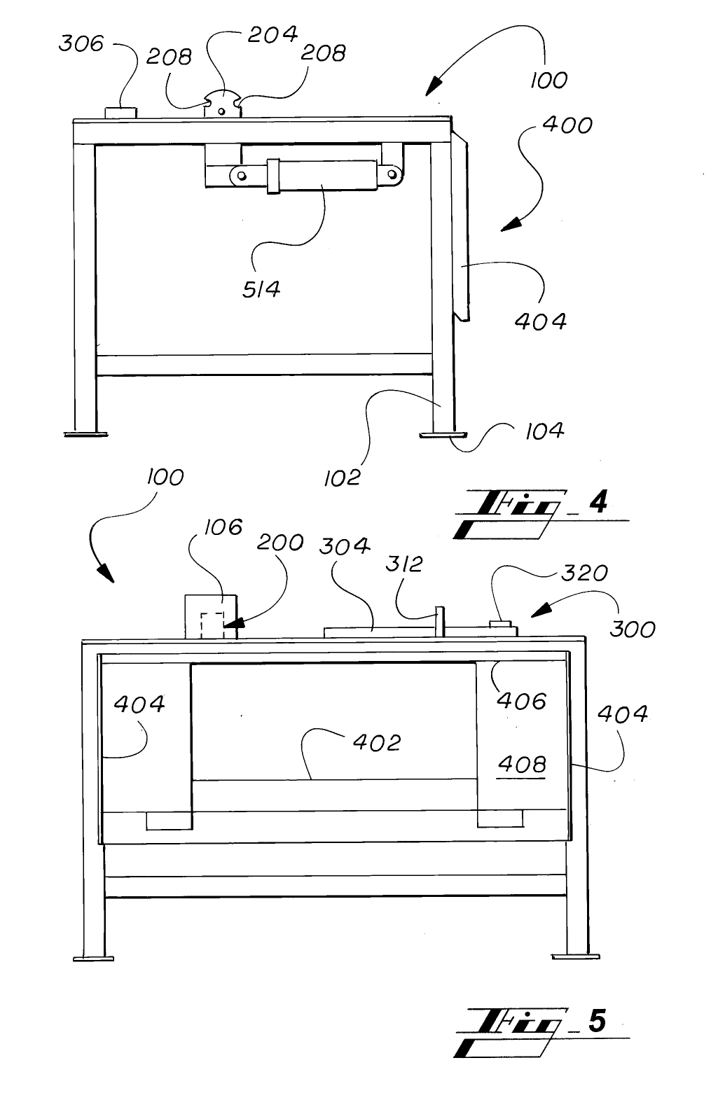

Illustrated in FIGS. 1-10 is an embodiment of a rebar processing station according to the present disclosure, and taking the form of an hydraulically powered rebar cutting, bending, and shaping table 100. Table 100 is preferably formed from durable, structural steel component parts, each of which may be treated, as appropriate, against weathering, rusting, and/or the like.

As may be seen with reference to FIG. 1, table 100 is configured with rebar cutting assembly 200, and with rebar grasping, bending, and shaping assembly 300. Preferably, at the rear of table 100 is transport assembly 400, allowing for cooperative engagement with appropriate attachments and/or implements associated with on-site construction equipment, as described elsewhere herein. Hydraulic power system 500 is provided for actuation of rebar cutting assembly 200 and rebar grasping, bending, and shaping assembly 300.

In some embodiments, rebar cutting assembly 200 comprises a pair of hardened shearing plates or dies 202, 204. In the embodiment shown, shearing plate 202 is preferably stationary and firmly affixed to table 100, while shearing plate 204 preferably articulates about pivot center 206. Pivot center 206 may take the form of a hardened steel pin or bolt and cooperating hole.

Each shearing plate or die 202, 204 comprises one or more peripheral, U-shaped slot or channel 208, configured to align with a respective, corresponding U-shaped slot or channel 208 in the other adjacent shearing plate or die. Each U-shaped slot or channel 208 is appropriately sized to receive rebar R therewithin, and when operating thereupon, cuts rebar R by shearing force at the interface I between the adjacent shearing plates. In some embodiments, left and right-hand U-shaped slots or channels 208 may be provided within each shearing plate or die 202, 204 for the convenience of the operator.

In some embodiments, rebar grasping, bending, and shaping assembly 300 comprises rebar grasping means 302, fixed-position shaping plate or die 304, and a movable former 306, such as a bearing-mounted roller. Rebar grasping means 302 may comprise a clamp formed by cooperative interaction between a first, fixed-position, tapered clamp portion 308 and a second, slidable, cooperatively-tapered clamp portion 310.

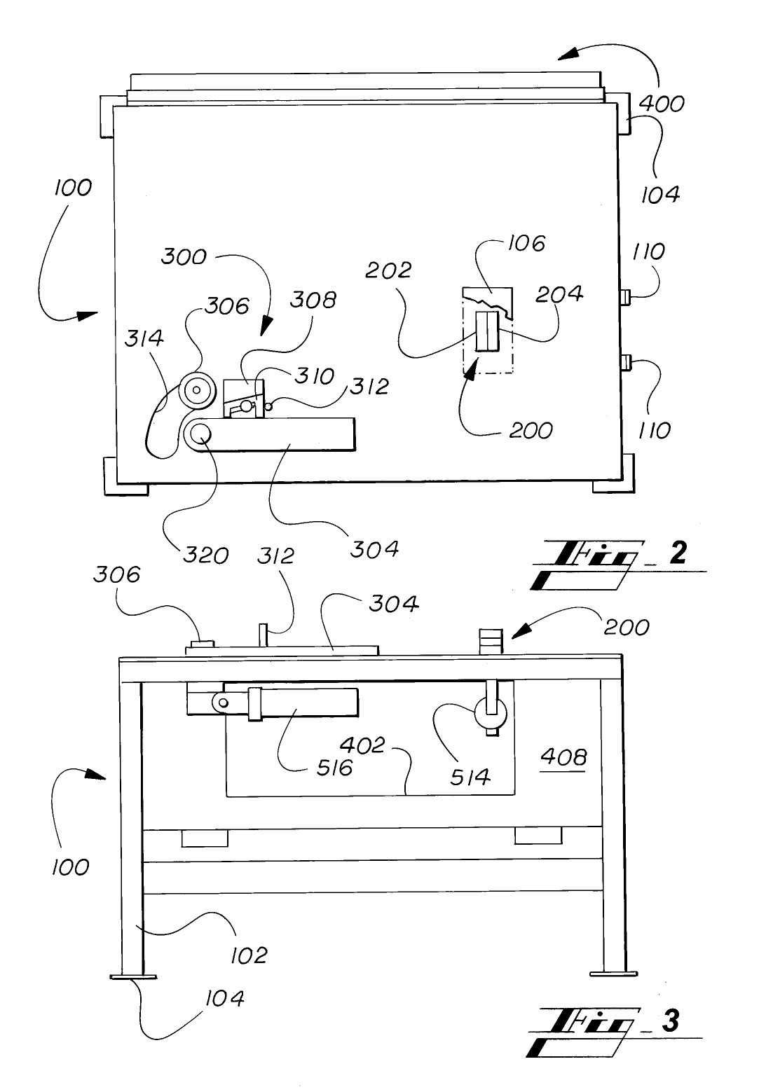

Best seen with reference to FIGS. 2, 6, and 7, second, slidable, cooperatively-tapered clamp portion 310 may be engaged with table 100 via slot 316 and screw and washer assembly 318. Fixed-position shaping plate or die 304 may be affixed to table 100 via steel weldment 320.

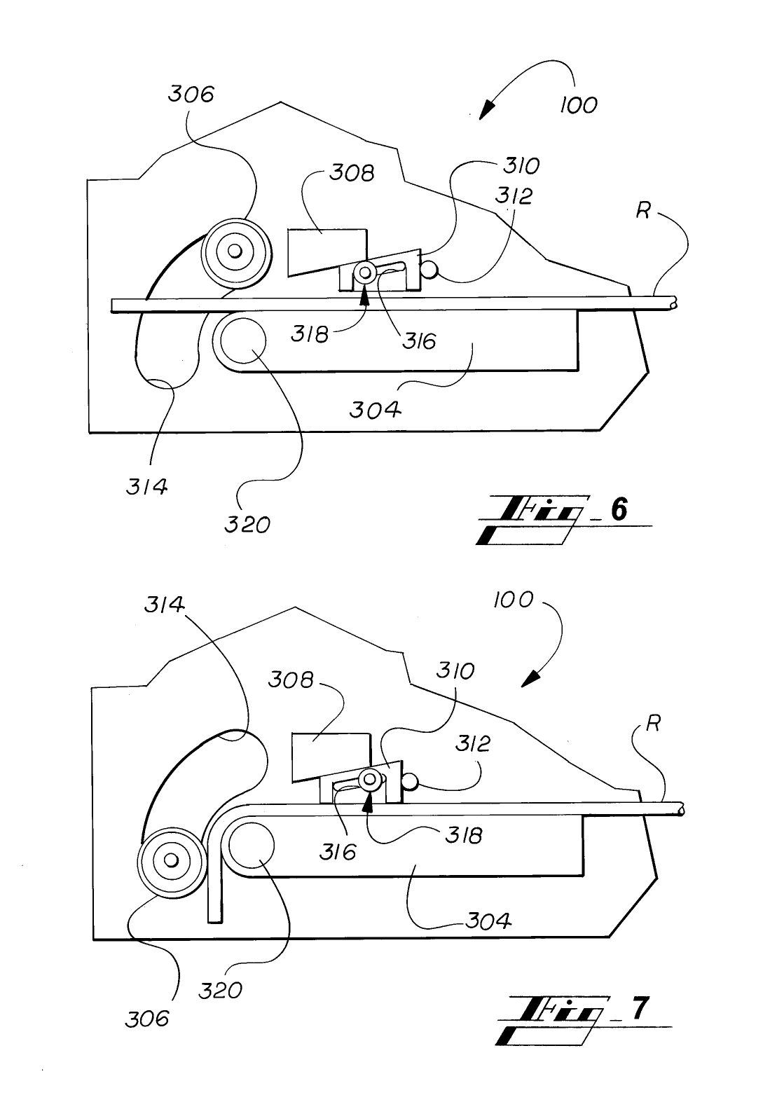

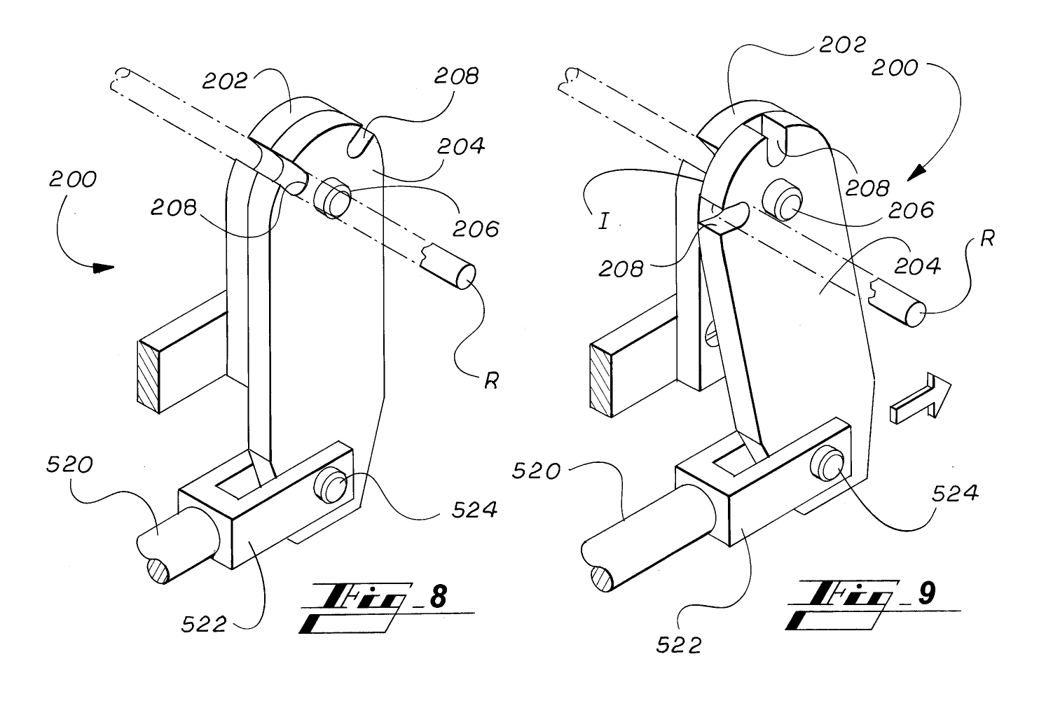

With continuing reference to FIGS. 6 and 7, in operation, one side of rebar R is placed adjacent fixed-position shaping die 304, and slideable, tapered clamp portion 310 is engaged via handle 312 against the opposite side of rebar R; thereby, clamping or grasping rebar R between fixed-position shaping plate or die 304 and grasping means 302 clamp in a stable and stationary position.

Provided that the distal portion of the rebar is of sufficient length to be engaged by movable former 306, which in some embodiments takes the form of a hardened steel, bearing-mounted roller operating within an arcuate field of travel defined by slot 314, rebar R may be bent and shaped by operation of movable former 306 against rebar R, bending rebar R about adjacent, fixed-position shaping plate or die 304. Provided, of course, that the applied bending forces are sufficient to exceed the yield strength of rebar R, the bending operation is permanent; and rebar R, accordingly, is shaped to the desired configuration.

Because these rebar cutting, bending, and shaping processes often occur contemporaneously with site preparation activities, such as site excavation, grading, and compaction; and, because construction materials must be staged and moved about the construction site, hydraulically-equipped loaders, excavators, tractors, ancillary hydraulic motors and/or power packs, and similar machines, are typically available on-site, and can be enlisted to transport and relocate table 100 about the site, as required. Accordingly, table 100 may be provided with appropriate features, such as transport assembly 400, allowing cooperative engagement of table 100 with appropriate attachments and/or implements associated with such machines.

Returning to FIGS. 1 and 5, transport assembly 400 may provide opening 402, which may cooperatively interface with a protruding portion of a stepped plate or other attachment (not shown) associated with a piece of lifting and transport equipment. Lateral support rails 404, upper support rail 406, and facing plate or plates 408 may be provided to cooperatively interface with an outer portion of the stepped plate or other attachment (not shown) associated with the piece of lifting and transport equipment. Each facing plate 408 may be configured at a lower distal portion with angled portion 410. Angled portion(s) 410 may assist in guiding the stepped plate or other attachment (not shown) associated with the piece of lifting and transport equipment into proper alignment and position with transport assembly 400; thereby, ensuring stability and effective securement of table 100 to the lifting and transport equipment.

Once the hydraulically powered rebar cutting, bending, and shaping table 100 of the present disclosure has been placed in a desired on-site location, the aforedescribed hydraulically-equipped loaders, excavators, tractors, ancillary hydraulic motors and/or power packs, and similar machines can be conveniently utilized to power table 100 through use of such hydraulic power out-takes and/or outputs typically available on such hydraulically-equipped machines. With continuing reference to FIG. 1, hydraulic lines 502, 504 may be provided for interconnecting with such available hydraulic power out-takes and/or outputs in typical hydraulic feed-and-return loop configuration. Hydraulic lines 502, 504 may be supported by and affixed to table 100 via clamp 506 and post 508. Clamp 506 and post 508 may be provided with spring 510, which may bear against washer 512 at an end thereof, to provide cushion for hydraulic lines 502, 504 against impact and flexing forces.

Best seen with reference to FIGS. 3, 4, and 10, hydraulic lines 502, 504 are operably connected to hydraulic actuation cylinders 514, 516. In the embodiment shown, hydraulic actuation cylinders 514, 516 are arranged in series, with a common, single actuation control system. In such embodiment, rebar cutting assembly 200 and rebar grasping, bending, and shaping assembly 300 are configured to operate essentially simultaneously. It will be apparent, however, that hydraulic actuation cylinders 514, 516 may be part of separate hydraulic loops, each loop having an independent actuation control system. In such alternate embodiments, rebar cutting assembly 200 and rebar grasping, bending, and shaping assembly 300 may be configured to operate independently.

As may be seen in FIGS. 8-10, hydraulic actuation cylinder 514 is affixed at one end to stationary mount 518. In order to facilitate operation of rebar cutting assembly 200, ram 520 of hydraulic actuation cylinder 514 is affixed at the other end to a lower distal end of articulating shearing plate 204 via clevis 522 and pin or bolt 524. As force is applied via hydraulic actuation cylinder 514, articulating shearing plate 204 pivots about pivot center 206, and thereby provides shearing force to cut rebar R.

Similarly, and with continuing reference to FIG. 10, hydraulic actuation cylinder 516 is affixed at one end to stationary mount 526. In order to facilitate operation of rebar grasping, bending, and shaping assembly 300, ram 528 of hydraulic actuation cylinder 516 is affixed at the other end to a distal end of articulating cam plate 530 via clevis 532 and pin or bolt 534. As articulating cam plate 530 is rotated by operation of hydraulic actuation cylinder 516 about pin or bolt 536 in stationary support 538, movable former 306 travels within an arcuate field of travel defined by slot 314, as best shown in FIGS. 6-7. Accordingly, in use and operation, rebar R may be bent and shaped by operation of movable former 306 against rebar R, bending rebar R about adjacent, fixed-position shaping plate or die 304.

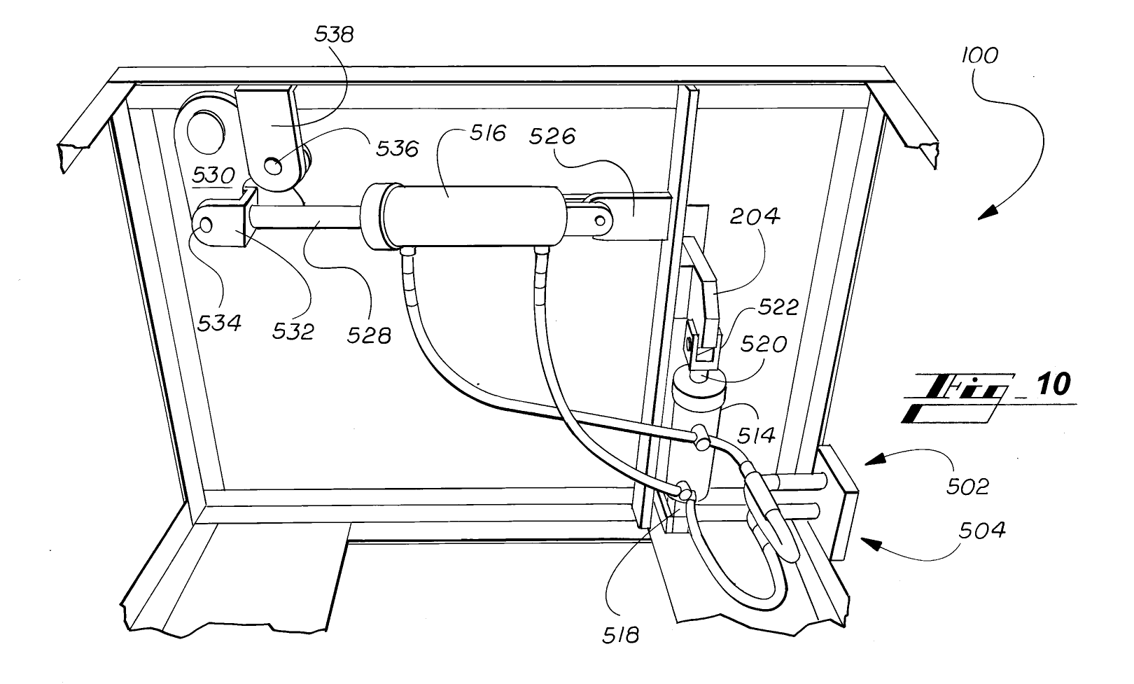

In use and operation, and with continuing reference to FIGS. 8-9, rebar R is placed within U-shaped slots or channels 208 of cutting assembly 200, the preferred cut-point is aligned along shear interface I between adjacent shearing plates 202, 204, and cutting assembly 200 is actuated so as to cut rebar R to its preferred length. Best seen with continuing reference to FIGS. 6-7, one side of rebar R is then placed adjacent fixed-position shaping die 304, and slideable, tapered clamp portion 310 is engaged against the opposite side of rebar R; thereby, clamping or grasping rebar R between fixed-position shaping plate or die 304 and clamp 302, 308, 310 in a stable and stationary position. Movable former 306 is actuated; whereby, provided that the distal portion of rebar R is of sufficient length to be engaged by movable former 306, rebar R is bent and shaped by operation of movable former 306 against rebar R, bending rebar R about adjacent, fixed-position shaping plate or die 304. Provided, of course, that the applied bending forces are sufficient to exceed the yield strength of rebar R, the bending operation is permanent; and rebar R, accordingly, is shaped to the desired configuration. The aforedescribed process, or subprocesses thereof, may be repeated as-required to bring each rebar R into conformance with its corresponding specification. Through use of the aforedescribed process(es), compound bends may be achieved by reorienting rebar R at the desired location of, and in accordance with, the required bend, and repeating the bending operation.

In some embodiments, table legs 102 can be made extensible, as with cooperating pin and hole arrangements associated with multi-part legs. In some embodiments, table legs 102 may be provided with plate cleats 104 to provide stability and leveling capabilities.

In some embodiments, shields and/or covers 106 may be provided for worker safety during table operation, and to protect moving components of table 100 against impact and damage when table 100 is not in operation. In some embodiments, shields and/or covers 106 may be affixed to table 100 via tether 108. In some embodiments, set-aside shields and/or covers 106 may be supported, when not in use, by hangers 110 upon table 100, best seen with reference to FIG. 2.

It will be apparent that rebar of any of a variety of sizes, shapes, and/or materials may be used in association with table 100, so long as appropriate to the configuration and power profile of the table.

It will also be apparent that, in other embodiments, fixed-position shaping plate or die 304 may be provided in an alternative shape and/or size than has been described and depicted herein, in order to accommodate other, different, and/or further bend specifications. Specifically, in some embodiments, a fixed-position shaping plate or die 304 having a length of approximately 9-10 inches from front radius to heel may be preferred for projects in which rebar bending specifications call for compact, multiple (or consecutive) bends, such as those that might be found, for example, within rectangular-shaped rebar sections used within footings. It will be apparent that such length of fixed-position shaping plate or die 304 will allow one to form, for example, a 12 inch rectangular rebar footing section, without interference or obstruction by fixed-position shaping plate or die 304. Of course, it will be further apparent that appropriate adjustments may be necessary in the design and/or configuration of table 100, and associated elements, in order to accommodate other or alternative forms of fixed-position shaping plate or die 304.

It will be further apparent that, in some appropriately configured embodiments, table 100 may be pneumatically and/or electrically powered, in lieu of, in association with, or in addition to, the use of hydraulic power systems of the type that have been described herein.

Having thus described exemplary embodiments of the subject matter of the present disclosure, it is noted that the within disclosures are exemplary only and that various other alternatives, adaptations, and modifications may be made within the scope and spirit of the present invention. For example, while the disclosure set forth hereinabove has been provided with reference to materials such as construction rebar, the subject matter could be extended to use in association with many other relatively slender, cylindrical, solid or tubular, bendable materials which preferably may be cut by shearing without performance-degrading deformation adjacent the shear plane.

Accordingly, the present subject matter is not limited to the specific embodiments as illustrated herein, but is only limited by the following claims.

What is claimed:

1. A rebar processing station comprising:
a table, said table comprising first and second rebar processing substations, said first rebar processing substation comprising a rebar cutting assembly, and said second rebar processing substation comprising a rebar grasping, bending, and shaping assembly;
said rebar cutting assembly comprising a first shearing plate that is stationary and affixed to said table and a second shearing plate that is configured to rotate about a pivot center, said first and second shearing plates each comprising a peripheral, U-shaped slot or channel configured to receive a portion of a rebar, said U-shaped slots or channels configured to align respectively when said second shearing plate is in an initial, rebar receiving position, said U-shaped slots or channels configured to be offset when said second shearing plate is in a rotated, rebar shearing configuration;
said rebar grasping, bending, and shaping assembly comprising a rebar grasping means, a fixed-position shaping plate or die, and a movable former; and
a power connection carried by said table and operably associated with each of said rebar cutting assembly and said rebar grasping, bending, and shaping assembly.

2. The rebar processing station of claim 1 wherein a grasping means of said rebar grasping, bending, and shaping assembly comprises a clamp formed by cooperative interaction between a first, fixed-position tapered clamp portion and a second, slidable, cooperatively-tapered clamp portion.

3. The rebar processing station of claim 2 wherein said second, slidable, cooperatively-tapered clamp portion may be engaged with said table via a slot, screw, and washer assembly.

4. The rebar processing station of claim 1 wherein said pivot center associated with said second shearing plate comprises a hardened steel pin or bolt and a cooperating hole.

5. The rebar processing station of claim 1 wherein said first and second shearing plates comprise a rebar shearing interface therebetween.

6. The rebar processing station of claim 1 wherein each of said first and second shearing plates comprise a corresponding first and second peripheral, U-shaped slot or channel configured to receive a portion of a rebar, said corresponding first and second U-shaped slots or channels configured to align respectively when said second shearing plate is in an initial, rebar receiving position, said corresponding first and second U-shaped slots or channels configured to be offset respectively when said second shearing plate is in a rotated, rebar shearing configuration.

7. The rebar processing station of claim 1 wherein said movable former comprises a bearing-mounted roller.

8. The rebar processing station of claim 7 wherein said bearing-mounted roller operates within an arcuate field of travel defined by a slot within said table.

9. The rebar processing station of claim 8 wherein a rebar may be bent and shaped by operation of bearing-mounted roller against the rebar, bending the rebar about said fixed-position shaping plate or die.

10. The rebar processing station of claim 1 further comprising a transport assembly disposed below a top of said table.

11. The rebar processing station of claim 10 wherein said transport assembly is configured to receive a protruding portion of a stepped attachment associated with a lifting or transport device.

12. The rebar processing station of claim 10 wherein said transport assembly comprises a plurality of lateral support rails, an upper support rail, and a facing plate to cooperatively interface with an outer portion of a stepped attachment associated with a lifting or transport device, said facing plate configured at a lower distal portion thereof with an angled portion to assist in guiding the stepped attachment into proper alignment and position with said transport assembly.

13. The rebar processing station of claim 1 wherein said power connection comprises an hydraulic power connection.

14. The rebar processing station of claim 1 wherein said power connection carried by said table is supported and carried by said table via a clamp, a post, and a spring.

15. The rebar processing station of claim 1 further comprising an hydraulic actuation cylinder associated with each one of said rebar cutting assembly and said rebar grasping, bending, and shaping assembly.

16. The rebar processing station of claim 16 wherein said hydraulic actuation cylinders are controlled by independent actuation control systems.

17. A rebar cutting, bending, and shaping table comprising:
a table, said table comprising a rebar cutting assembly and a rebar grasping, bending, and shaping assembly;
said rebar cutting assembly comprising a first shearing plate that is stationary and affixed to said table and a second shearing plate that is configured to rotate about a pivot center, said first and second shearing plates each comprising a peripheral, U-shaped slot or channel configured to receive a portion of a rebar, said U-shaped slots or channels configured to align respectively when said second shearing plate is in an initial, rebar receiving position, said U-shaped slots or channels configured to be offset when said second shearing plate is in a rotated, rebar shearing configuration;
said rebar grasping, bending, and shaping assembly comprising a rebar grasping means, said rebar grasping means comprising a clamp formed by cooperative interaction between a first, fixed-position tapered clamp portion and a second, slidable, cooperatively-tapered clamp portion, said second, slidable, cooperatively-tapered clamp portion engaged with said table via a slot, screw, and washer assembly, a fixed-position shaping plate or die, and a movable rebar former comprising a bearing-mounted roller operating within an arcuate field of travel defined by a slot within said table;
an hydraulic actuation cylinder associated with each one of said rebar cutting assembly and said rebar grasping, bending, and shaping assembly;
a transport assembly; and
an hydraulic power connection carried by said table and operably associated with each said hydraulic actuation cylinder.

17. The rebar processing station of claim 16 wherein said first and second shearing plates comprise a rebar shearing interface therebetween.

18. The rebar processing station of claim 16 wherein each of said first and second shearing plates comprise corresponding first and second peripheral, U-shaped slots or channels.

19. The rebar processing station of claim 16 wherein said hydraulic power connection carried by said table is supported and carried by said table via a clamp, a post, and a spring.

20. A process for cutting, bending, and shaping construction rebar comprising the steps of:
placing a section of rebar within a U-shaped slot or channel of a cutting assembly associated with a table;
aligning a referred cut-point along a shear interface between adjacent shearing plates of said cutting assembly;
actuating said cutting assembly so as to cut the rebar to a preferred length;
moving a portion of the cut rebar to a bending and shaping assembly associated with the table;
placing one side of the rebar against a fixed-position shaping plate or die associated with the table;
engaging a slideable, tapered clamp portion associated with the table against an opposite side of the rebar with sufficient force so as to hold the rebar in a stable and stationary position; and
actuating a movable former associated with the table;
whereby, provided the distal portion of the rebar is of sufficient length to be engaged by the movable former, the rebar is bent and shaped by operation of movable former against the rebar, the movable former bending the rebar about the adjacent, fixed position shaping plate or die.
